(19) United States
(12) Patent Application Publication
(10) Pub. No.: US 2014/0279270 A1
(43) Pub. Date: Sep. 18, 2014

(54) PRE-ORDERING BASED ON LOCATION OF A CUSTOMER

(71) Applicant: BANK OF AMERICA CORPORATION, Charlotte, NC (US)

(72) Inventors: Peter John Bertanzetti, Charlotte, NC (US); Laura Corinne Bondesen, Charlotte, NC (US); Matthew A. Calman, Charlotte, NC (US); David M. Grigg, Rock Hill, SC (US); Scott Lee Harkey, Concord, NC (US)

(73) Assignee: BANK OF AMERICA CORPORATION, Charlotte, NC (US)

(21) Appl. No.: 13/829,551

(22) Filed: Mar. 14, 2013

(51) Int. Cl. G06Q 30/06

(52) U.S. Cl. CPC G06Q 30/0635
USPC 705/26.81

(57) ABSTRACT

Embodiments of the invention relate to systems and methods that enable a user to pre-order products from an internal or external organization. The organization procures the products and/or completes the pre-order, such as completes a payment for the pre-order or finishes the pre-order, based on the location of the user, as determined through the user's mobile device. The order is only completed when the customer location is determined to be within a desired location of the collection point for the pre-order. Preparation of the products pre-ordered by the user commences upon the user location satisfying a predetermined criteria, such as the user being located an approximate distance from a particular location, the user having an approximate arrival time from a particular location, the user located within an electronic geographic fenced area around a particular location, or the user identified as moving with respect to a particular location.

### BACKGROUND

Pre-ordering goods or services (hereinafter “products”) allows a user to receive or purchase products outside of the business in order to save time. Users and businesses may want to improve upon pre-ordering systems and methods to further save time in purchasing products.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the invention relate to systems and methods that enable a user (e.g., customer, employee, or the like) to pre-order products from an internal or external organization (e.g., business, merchant, or the like). The organization procures (e.g., makes, assembles, gathers, places in pick-up, creates, produces, or the like) the products and/or completes the pre-order, such as completes a payment for the pre-order (e.g., debit or credit a user account, create a transaction slip or invoice, deduct funds from a user account, or the like), or finishes the pre-order, based on the location of the user, for example through a location determining device, such as a user's mobile device (e.g., smartphone, or the like).

Embodiments of the invention allow a user to place an order and the order is only completed when the customer location is determined to be within a desired location of the collection point for the pre-order. Preparation of the products pre-ordered by the user commences upon the user location satisfying a predetermined criteria, such as the user being located an approximate distance from a particular location, the user having an approximate arrival time from a particular location, the user located within an electronic geographic fenced area around a particular location, or the user identified as moving with respect to a particular location. For example, a customer may pre-order take out from a restaurant merchant and upon the user traveling within a geographically fenced area defined around the merchant, the merchant receives a notification to begin preparation of the take out order. The merchant has the customer's order ready at a point it time that closely relates with the customer's determined location. In other examples, the invention may reduce wait times, improve efficiency, or improve security at gas stations, restaurants, valets, parking lots, shopping malls, groceries stores or the like. In other embodiments of the invention, the pre-order may be a print job that an employee makes related to sensitive material, such as for example sales data or personal financial data. The user may print the document from the location of the user's computer, however, the print job will not be initiated and/or completed until it is determined that the user is within a specific distance (e.g., 3 feet) from the printer. In this way the present invention prevents secure documents from being potentially compromised.

Embodiments of the invention comprise systems, computer program product, and methods comprising receiving a pre-order for a product from a user; collecting location data of the user; analyzing the location data of the user to determine a proximity of the user from an organization location, and receiving a notification to procure the product for the user based in part on the proximity of the user from the organization location.

In further accord with embodiments of the invention, collecting location data of the customer comprises receiving the location data based on the location of a user's mobile device.

In another embodiment of the invention, collecting location data of the user comprises identifying when the user enters an electronic fenced location.

In still another embodiment of the invention, collecting location data of the user comprises identifying a user location when the user enters the pre-order, or at a time proximate to entering the pre-order; and identifying the user location at one or more later points in time.

In yet another embodiment of the invention, collecting location data of the user comprises identifying a user location when the user is located a pre-determined distance away from the organization location.

In further accord with an embodiment of the invention, analyzing the location data of the user comprises determining an estimate of a user arrival time at the organization location.

In another embodiment of the invention, analyzing the location data of the user comprises determining an estimate of a user arrival time at the organization location, determining an estimate of a procuring time related to a time it takes to procure the product from the pre-order, and wherein receiving the notification to procure the product for the user based in part on the proximity of the user from the organization location comprises receiving the notification based on a comparison of the estimate of the user arrival time and the estimate of the procuring time.

In still another embodiment of the invention, the invention further comprises completing the pre-order for the product after the user is within a pre-determined proximity from the organization location by accessing a payment from a user account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a process flow for communicating and processing orders for products using positioning data, in accordance with an embodiment of the present invention;

FIG. 2 provides a process flow illustrating a process flow for collecting positioning data of the customer, in accordance with an embodiment of the present invention;

FIG. 3a provides a mixed block and process flow illustrating a process for communicating and processing orders for products, in accordance with an embodiment of the present invention;

FIG. 3b provides a mixed block and process flow illustrating a process for communicating and processing orders for products, in accordance with an embodiment of the present invention; and

FIG. 4 provides a system environment illustrating technical components of a system for communicating and processing orders for products, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

FIG. 1 illustrates a high-level process flow for a location based pre-ordering process 100 that communicates and processes pre-orders using user location information. As illustrated by block 110, a user (e.g., customer, or the like) first places a pre-order for a product with an organization (e.g., merchant, or the like). In some embodiments of this invention the pre-order may be for goods such as a food, groceries, clothes, furniture, printed materials, or the like, or the pre-order may be for services such as reservations for restaurants, movies, plays, car services, or any other like service. As an example of the present invention described herein, a customer may place a pre-order for food from a restaurant over the Internet through the use of a customer computer system, such as a mobile device. For example, a customer may make a pre-order from merchant A for lunch thirty minutes (30) before the customer expects to pick up lunch. In some embodiments the customer may decide to leave for lunch early, or may otherwise leave late for lunch, such that as the customer arrives the food may not be ready or may become cold if the customer is late.

As illustrated by block 120 in some embodiments the pre-order may include collecting location data of data of the user indicating the location from which the user makes the pre-order. In other embodiments of the invention, the pre-order may not include the collection of location data of the user. Therefore, the collection of the location data of the user may occur at a point in time that coincides with the pre-order or occurs at a point in time after the pre-order is made. In this way, the organization may be able to determine the distance the user is from the organization's location. The in the embodiment described herein, the customer's location may be determined to be fifteen (15) minutes away from merchant A, as the customer places the pre-order for food with merchant A.

Furthermore, as illustrated by block 130, and as described in further detail later, in some embodiments of the invention the user's position may be continuously located, determined in particular time intervals, or determined the when user enters a geographically fenced location (e.g., an electronic geographically fenced location). The user location(s) may be analyzed to determine the likely user arrival time at the organization, or it may be determined that the user is within a particular distance from a desired location. Regardless of how the user's location is identified, the organization may be notified when the user meets a predetermined proximity (e.g., distance, location, time, or the like) from the organization location. In some embodiments the analysis may include determining the proximity of the user location and comparing it against the amount of time it takes for the organization to procure the product of the pre-order. The organization may receive a notification when the proximity of the user meets or is similar to the time to procure the product. The organization may set a predetermined parameter for receiving the notification based on the user location and product procurement time. For example, in the embodiment described herein, merchant A knows that it takes five (5) minutes to create the customer's food order, and the customer initial position is ten minutes (10) away. Merchant A may have set up a system to receive a notification when the customer is determined to be approximately six (6) minutes away.

otherwise the organization may be notified through an alert or notification

As illustrated in block 140, once it is determined that the user is in the process of traveling to the organization, is within a fenced location of the organization, or is a particular distance away from the organization after placement of the pre-order, the organization procures the user's order. In further accord with the example described herein, the once merchant A identifies that the customer is approximately six (6) minutes away the merchant produces the customer's food order, such that the customer's order is fresh and/or hot by the time customer arrives to pick up the customer's order.

FIG. 1 further illustrates in block 150 that once the organization identifies that the user is in route to the organization's location, or within the fenced location area, the organization may complete the transaction for the pre-ordered product accessing payment, creating a transaction slip, executing the pre-order, or the like. In the embodiment described herein, merchant A assesses payment from the customer's account through the customer's financial institution. In other embodiments of the invention, the payment for the pre-order is made as the initial pre-order is made. Therefore, in some embodiments, the user's payment information may be on file with the organization, may be provided by the customer during the pre-order, or may be automatically assessed as the user nears a terminal at the organization. In still other embodiments of the invention the customer may wait to pay using traditional methods after the customer receives the products from the merchant.

FIG. 2 illustrates a customer location process flow 200 for further defining the step of collecting the location data related to the location of the user that was described in block 120 of FIG. 1. As represented by block 210, the location of the user may be determined by using global positioning data. Global positioning data may include any information collected from methods, systems, apparatus, computer programs, or the like, involving locating a user's position relative to satellites, fixed locations, beacons, transmitters, or other like device. In some instances, global positioning data may be collected from a GPS device, such as a navigation system. Such a navigation system may be, but is not limited to, hardware and/or software that is part of a mobile phone, smartphone, PDA, automobile, watch, electronic payment device, a commercially available personal navigation system, or other like device. The amount, nature and type of the global positioning data that is collected may depend on the organization's relationship with the user and the amount of information that the user has authorized the organization or third-party provider to collect. For instance in some embodiments the global positioning data will be snapshots of the user's location at different times. For example, a snapshot of the user's location may be collected each time the GPS software, navigation system, or application is activated. The global positioning data may also include the destination entered by the user, recent searches for locations, attractions, addresses, or the like. In other instances, the global positioning data may be the complete route being provided to the GPS system's user, including destination, route, alternate routes, anticipated time of arrival, or the like. In some such embodiments, the global positioning data may include an indication if the user selects a detour from a previously selected route, or instructs the navigation system to reach the desired location taking specific roads or avoiding certain roads. In instances where the user's complete route is provided, additional positioning data may not be necessary to project the route of the user or can be used to confirm the user is traveling on along the suggested route.

As shown in block 220 of FIG. 2, location data of the user may include mobile device data. Mobile device data may include information regarding the location of the user's mobile device. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. For instance, the location of a mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data may further include information from an accelerometer that is a part of the mobile device and provides information regarding whether the mobile device is moving, and if so, in what direction. In some embodiments, mobile device data may be the time and location of calls placed using the telephone functionality of a mobile device. In yet other embodiments, the mobile device data may be data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (e.g., from a compass in the mobile device). Such information may be sufficient to locate the user's location and potentially the direction the user is facing and/or traveling. Furthermore, in other embodiments of the invention a geographic location, district within a business, groups of merchants, a single merchants location may be electronically fenced with a positioning information, such that the once a customer enters the fenced location, the position of the customer within the fenced location may be identified. In some embodiments of the invention the fenced area may be a physically electronically fenced area (e.g., using wired fenced buried, beacon posts located around a perimeter, or the like), a wireless network that covers a particular area, or other like area that may be at least partially be defined electronically. In some embodiments the electronically fenced areas may overlap, or be contained within one another, such that a customer's movement within and/or between different electronically fenced areas may be determined or estimated relatively accurately.

Referring now to block 230, the location data of the user may also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, like, relationships, beliefs, knowledge, prestige, geographic proximity, or the like. The social network may be a web-based social structure or a non-web-based social structure. In some embodiments, the social network may be inferred from financial transaction behavior, mobile device behaviors, or the like. The social network may be a network unique to the invention or may incorporate already-existing social networks, as well as any one or more existing web logs or “blogs,” forums and other social spaces. Social network data may indicate the customer's recent, present or future location through expressed data. For instance, a user may upload a blog post, comment on a connection's page, send a friend an electronic message, or the like, that she is traveling to a specific location or that she is currently in a specific city, or on a specific road, or the like. Moreover, many already-existing social networks provide users with the ability to “check-in”, “flag” or otherwise indicate the user's current location. Accordingly, user positioning data collected from social networking data may consist of such indications. Furthermore, many social networks allow users to rate, like, comment, or the like, on restaurants, attractions, locations or the like. Accordingly, a user may indicate that she ate at a certain restaurant or business at a given time and thereby provide information about her location at that time. Furthermore, a user may upload photographs to a social networking site and thereby provide information about the user's location. In some instances the user's location may be determined from the picture, (for example a picture of a state line sign, a highway sign, a mile marker, or the like) or a caption associated with the picture may indicate the user's location and/or the time the photo was taken.

As shown in block 240, the location data of the user may also be collected from Internet data. Internet data, may include any information relating to the searches conducted by the user, website's visited by the user, or the like that suggests the customer's present or future location(s). For instance, in preparing for a vacation a user may conduct searches for hotels, restaurants or activities in the area where the user will be staying. Similarly, a user may review weather forecasts for locations other than her place of residence indicating that she may soon be traveling to that location. A user may also search for construction or traffic reports indicating future travel along certain roads. Moreover, changes in search patterns may suggest a user's future location. For instance if a user usually uses a web browser application just to read online news articles or to check sports scores but suddenly begins to search for camping gear, hiking manuals and boots it may be indicative that the user is anticipating taking a hiking trip and will be traveling away from her home area. It will be understood that such Internet data may relate to searches or websites visited by the user before she began traveling, however, inasmuch as many mobile devices also include mobile Internet connectivity, it will also be understood that such information may be dynamically collected as the user travels.

As previously described with to block 130 in FIG. 1, and further described herein, once the location data of the user is collected from one or more of the global positioning data 210, mobile device data 220, social network data 230, and/or Internet data 240, the location data is analyzed to project the user's likely arrival time at the organization. It will be understood that the positioning data may be data that is available directly to the organization receiving the pre-order, such as the pre-order merchant (e.g., as further illustrated in FIG. 3a), data that is collected by other organizations (e.g., other merchants, third-party service providers, or the like) and then provided to the organization receiving the pre-order, or data that is collected by a financial institution (e.g., as illustrated in FIG. 3b) and then provided to the organization receiving the pre-order.

In some instances analyzing the user's location comprises projecting the user's likely route of travel. This projection may be based on the information currently being collected, such as the user's current GPS location, the most recent social network and Internet search data, or the like. In other instances, current user location data may be combined with historical positioning data to project the user's likely route of travel. For instance, if historical positioning data indicates that when the user leaves her work and walks down a particular street, ninety percent of the time she does not stop at other locations before arriving at a specific location. For example, in the embodiment previously discussed herein, once merchant A identifies that the customer is headed down a particular street towards the merchant's location, merchant A may realize that 90 percent of the time customer will arrive at the merchant location within 8 to 10 minutes. This information may be used in the present invention to assemble the customer's pre-order, and have it ready for pick-up in 8 to 10 minutes. Similarly, the positioning data being currently collected about the user may be combined with information regarding the travel patterns of other users in similar situations to project the customer's likely route of travel.

FIGS. 3a and 3b, provide a mixed block and flow diagram illustrating a user location product ordering process 300 for communicating and processing pre-orders for a product and completing the order based on the user's location at one or more points in time, in accordance with embodiments of the present invention. As shown, in some embodiments, steps of the user location product ordering process 300 are performed by the user, an organization, or a third party (e.g., financial institution, software provider, or the like). The user location product ordering process 300 allows a user to opt into a program that allows the organization to be notified when a user is on the way to pick-up a pre-ordered or pre-purchased product. The organization collects positioning data and projects a likely arrival time of the user. The organization assembles of the product that the user ordered process the order and have the product ready or the user in a more efficient way. Moreover, in some embodiments, as illustrated by FIG. 3b, instead of the organization identifying the location of the customer, a third party, such as the financial institution that the user is using to pay for the transaction, provides the organization with the user's location or the user's likely arrival time, in order to allow the organization time to prepare the user's order.

As illustrated in block 310 of both FIGS. 3a and 3b, a user places a pre-order for a product from an organization. As previously described the order may be placed electronically over the Internet, and in some instances using the user's mobile device, or other user computer system. In some embodiments the pre-order may also contain payment information related to the user account from which the user wishes to make the payment. In other embodiments, the user's location at the time of purchase may also be included in the pre-order information in the situations in which the determination of the user's location has been previously described herein. In still other embodiments of the invention the user may enter a time frame for pick-up such that the user's location, as discussed in further detail below, is only searched, identified, determined, or the like during the time-frame indicated by the user during the pre-order (or otherwise at another time indicated by the user).

As shown in block 320, the organization receives the pre-order made by the customer, such as through the organization's online ordering system. In other embodiments the pre-order received by the organization may be made through a third-party ordering system that passes the user's order onto the organization. In other embodiment of the invention the user may order through other ways specifically or not specifically described herein.

As illustrated by block 330, at some point after the user places the pre-order the user may leave to pick up the product ordered. In the present invention, this could be immediately after the user makes the order, or any point in time after the user makes the purchase. In some embodiments of the invention the user makes the pre-order as the user is already on the way to the organization.

FIGS. 3a and 3b illustrate in block 340 that the user's location is determined. In FIG. 3a, block 340 illustrates that the organization identifies user's location. Alternatively, in block 340 FIG. 3b, the financial institution identifies the user's location. As illustrated by block 345 of FIG. 3b the organization receives a notification of the user's location from the financial institution. In still other embodiments of the invention, instead of the financial institution or organization that receives the pre-order, a third-party may be the entity that determines the user's location and delivers the notification information of the user's location to the organization. For example, in some embodiments a location application on a user's mobile phone run by a third-party organization or software may determine the location of the user and send a notification of the user's location to the organization. In one embodiment, as previously discussed with respect to block 120 in FIGS. 1 and 2, this may comprises identifying if the location of the user when the order was placed, at various points of time over a period of time, or when the user reaches a particular distance away from the organization.

FIGS. 3a and 3b, both illustrate in block 350 that the organization analyzes the location information collected by the organization or received by the organization from another entity (e.g., financial institution or other third-party). As previously described herein the analysis may include determining the estimated arrival time of the user at the organization location. In other embodiments of the invention, the analysis may include identifying the distance the user is located away from the organization's location, the estimated arrival time of the user, and/or other like analysis of the user location information. As discussed with respect to block 340 related to the determination of the user's location, the analysis of the user's location information may be done by the organization as illustrated, or in other embodiments may be done by the financial institution, or other third-party entity. The analysis of the user location information may allow the organization to identify when to procure the order for the user and have it ready for the user before the user arrives, as previously described.

As illustrated by block 360, the organization procures the user's order before the user arrives, as the user arrives, or shortly thereafter. For example, as described with respect to the embodiment discussed herein merchant A may begin making or processing the user's take out order, such that it is fresh when the customer arrives. In another example, the organization may gather the user's order such that it is assembled and ready for pick up when the user arrives, such as when the order is for groceries from a supermarket.

Block 370 of FIGS. 3a and 3b, further illustrate that the organization completes the pre-order by assessing a payment from the user by sending a notification to the financial institution indicated by the user in the pre-order, or otherwise previously stored by the organization or user. In other embodiments, as previously described herein, the user payment may be finalized at anytime during the process from the pre-order time to when the user picks-up the order and finalizes the order, or outside of this period of time.

As illustrated by block 375, the financial institution receives the notice from the organization to assess the payment from the user's account for the transaction. In response to receiving the notice, as illustrated by block 380, the financial institution assess the payment from the user's account and sends notification to the organization and/or the customer that the user's account has been assessed and the transaction completed.

Block 390 in FIGS. 3a and 3b illustrates that the customer receives the product and completes the transaction by picking up the product from the organization.

In some embodiments of the invention, during the pre-order, the user may be able to indicate that the order is going to be picked up by another user (e.g., receiving user, or second user, or the like) other than the user that made the pre-order (e.g., ordering user, first user, or the like). In this way, the organization is notified by the ordering user that a receiving user is picking up the order, and thus, may search for, identify, and track the receiving user and not the ordering user. In this embodiment the ordering customer may include the receiving user's information in the pre-order, may transfer the receiving user's information to the organization at a later point in time, or otherwise allow the receiving user to authorize that the receiving user has permission to pick-up the order. In still other embodiments of the invention the account of the user may include pre-programmed parameters that list one or more other authorized receiving user that have the authority to pick-up the order, such that the organization, or other third-party, may track the estimated arrival time of one or more of the users that are authorized as receiving users.

In some embodiments of the invention, the pre-order may also be a print job, or other like event that a user, for example an employee, makes within the employee's own organization (or external organization in some embodiments). The organization location may be a printer, or other location within the organization, at which the user retrieves a product. The print job may be related to sensitive material, such as for example sales data or personal financial data. The user may print the document from the location of the user's computer; however, the print job will not be initiated, or otherwise be completed, until it is determined that the user is within a specific distance (e.g., 3 feet, on the same floor, or the like) from the organization location (e.g., printer). In this way the present invention prevents secure documents from being potentially compromised. This example, may also apply when a user is picking up sensitive information from another organization, for example, in the case of a courier.

FIG. 4 provides a system environment illustrating technical components of a system for communicating and processing orders for products, in accordance with an embodiment of the present invention. As illustrated in FIG. 4, one or more organization systems 510, one or more a financial institution systems 520, and one or more user computer systems 530 (e.g., mobile devices) are operatively and selectively coupled through the network 502. In other embodiments of the invention, another user, such as a receiving user, may also be connected to the other systems through the network 502 using a receiving user computer system (e.g., mobile device) that is the same or similar to the user computer system 530. In still other embodiments of the invention a third-party system may be connected to the other systems over the network 502 in the same way as described herein with respect to the other systems. The third-party system, in some embodiments may be used to receive and transmit the pre-orders, the payments for the pre-orders, and/or the user location data that facilitates the pre-order transactions.

The network 502 may be a global area network (GAN), such as the Internet, a wide area network (WAN), a local area network (LAN), or any other type of network or combination of networks. The network 502 may provide for wireline, wireless, or a combination of wireline and wireless communication between devices on the network 502.

As illustrated in FIG. 4, a user 504 accesses the organization system 510 (or third-party system) through a user computer system 530. As previously discussed herein, the user computer system 530 may be a desktop, laptop, tablet, mobile device (e.g., smartphone device), or any other type of computer that generally comprises a communication device 532, a processing device 534, a positioning device 535, and a memory device 536. As used herein, the term “processing device” generally includes circuitry used for implementing the communication and/or logic functions of a particular system. For example, a processing device 534 may include a digital signal processor device, a microprocessor device, and various analog-to-digital converters, digital-to-analog converters, and other support circuits and/or combinations of the foregoing. Control and signal processing functions of the systems are allocated between these processing devices according to their respective capabilities. The processing device 534 may include functionality to operate one or more software programs based on computer-readable instructions 538 thereof, which may be stored in a memory device 536. Each memory device described herein, including the memory device 536, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

The processing device 534 is operatively coupled to the communication device 532, the positioning device 535, and the memory device 536. The processing device 534 uses the communication device 532 to communicate with the network 502 and other devices on the network 502, such as, but not limited to, the organization systems 510, the financial institution systems 520, and/or other systems are operatively coupled to the network 502. As such, the communication device 532 generally comprises a modem, server, or other device for communicating with other devices on the network 502 and/or a keypad, keyboard, touch-screen, touchpad, microphone, mouse, joystick, other pointer device, button, soft key, and/or other input device(s) for communicating with the user 504.

As illustrated in FIG. 4, the user computer system 530 may have a positioning device 535, such as a GPS (or other like device described herein, or equivalent thereto), that allows a user's location to be captured if the user 504 opts into a service, program, application, or the like that allows others to locate the user 504. As further illustrated in FIG. 2, the user computer systems 530 may have computer-readable instructions 538 stored in the memory device 536, which in one embodiment includes the computer-readable instructions 538 of a web browser application 537 that allows the user 504 to access a pre-ordering application 517, the payment applications 527, or the like. In some embodiments, the memory device 536 includes a datastore 539 for storing data related to the user computer system 530, including but not limited to data created and/or used by the web browser application 537. The web browser application 537 may be used by the user 504 to access the pre-ordering application 517 and/or the payment application 527, to place a pre-order, make a payment, and provide location information or authorization to capture location information of the user 504 or another related customer.

As illustrated in FIG. 4, the organization systems 510 generally comprise a communication device 512, a processing device 514, and a memory device 516. The processing device 514 is operatively coupled to the communication device 512 and the memory device 516. The processing device 514 uses the communication device 512 to communicate with the network 502 and other devices on the network 502, such as, but not limited to, the user computer system 530 and the financial institution systems 520. As such, the communication device 512 generally comprises a modem, server, or other device for communicating with other devices on the network 502.

As further illustrated in FIG. 4, the organization systems 510 comprises computer-readable instructions 518 stored in the memory device 516, which in one embodiment includes the computer-readable instructions 518 of a pre-ordering application 517. In some embodiments, the memory device 516 includes a datastore 519 for storing data related to the organization systems 510, including, but not limited to, data created and/or used by the pre-ordering application 517.

The pre-order application 517 is a tool that allows a user 502 to place pre-order for a product with a user 504 and utilize customer location data to estimate the arrival time of the user 504 in order to prepare the product for pick-up.

As illustrated in FIG. 4, the financial institution systems 520 generally comprise a communication device 522, a processing device 524, and a memory device 526. The processing device 524 is operatively coupled to the communication device 522 and the memory device 526. The processing device 524 uses the communication device 522 to communicate with the network 502 and other devices on the network 502, such as, but not limited to, the user computer system 530 and the organization systems 510. As such, the communication device 522 generally comprises a modem, server, or other device for communicating with other devices on the network 502.

As further illustrated in FIG. 4, the financial institution systems 520 comprise computer-readable instructions 528 stored in the memory device 526, which in one embodiment includes the computer-readable instructions 528 of payment applications 527. In some embodiments, the memory device 526 includes a datastore 529 for storing data related to the financial institution systems 520, including but not limited to data created and/or used by the payment applications 527.

The payment applications 527 are used to provide the user 504 with the ability to make payments anytime during the pre-order through the completion of the pre-order after the product is picked-up or the transaction is completed at the organization location.

In some embodiments, the processors are capable of operating one or more applications, such as one or more applications functioning as an artificial intelligence (“AI”) engine. The processors may recognize, by way of the AI engine, projected travel routes, customer arrival times at a location, or the like. Once the AI engine has thereby “learned” of common routes, arrival times, or the like, the AI engine may run concurrently with and/or collaborate with other modules or applications described herein to perform the various steps of the methods discussed herein. The AI engine may then communicate to another application or the organization, an indication of the user's arrival time.

It will be understood that the embodiment illustrated in FIG. 4 is exemplary and that other embodiments may vary. For example, in some embodiments, some of the portions of the system environment 500 may be combined into a single portion. Specifically, in some embodiments, the organization systems 510 are configured to perform some of the same functions of those separate portions as described and/or contemplated herein. Likewise, in some embodiments, some or all of the portions of the system environment 500 may be separated into two or more distinct portions.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

Various embodiments or features were presented in terms of systems that may include a number of devices, components, modules, and the like. It is to be understood and appreciated that the various systems may include additional devices, components, modules, or the like, and/or may not include all of the devices, components, modules, or the like, discussed in connection with the figures. A combination of these approaches may also be used.

Embodiments of the present invention were described above with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Although embodiments of the present invention described herein are generally described as involving an organization, it will be understood that the organization may involve one or more persons, merchants, businesses, institutions and/or other entities such as financial institutions, services providers, or the like that implement one or more portions of one or more of the embodiments described and/or contemplated herein.

The embodiments described herein may refer to the use of a pre-order or transaction. Unless specifically limited by the context, a “transaction” refers to any communication between the user, the organization, the financial institution, or other entity involved with the pre-order made by the user. In some embodiments, for example, a transaction may refer to a purchase of a product (e.g., goods or services), a return of products, a payment transaction, a credit transaction, or other interaction involving a customer's bank account. As used herein, a “user account” refers to a credit account, a debit/deposit account, or the like. Although the phrase “user account” relates to a user account at a financial institution, the user account need not be maintained by a bank and may, instead, be maintained by other institutions (e.g., merchants). As further examples, a transaction may occur when an entity associated with the user is alerted via the transaction of the user's location. A transaction may occur when a user accesses a fenced area, building, or other identified location. A transaction may occur as a user's mobile device establishes a wireless connection, such as a Wi-Fi connection, with an organization's system, organization's defined location, or the organization's terminal. In some embodiments, a transaction may include one or more of the following: purchasing, renting, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills, or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's computer system, such as a user's mobile device. A transaction may take place at any location, virtual location, or otherwise proximate the organization's location where the occurrence of the product is transferred or used.

While certain exemplary embodiments have been described and shown in the accompanying drawings, it is to be understood that such embodiments are merely illustrative of, and not restrictive of the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system comprising:
a memory device having computer readable program code store thereon; and
a processing device operatively coupled to the memory device, wherein the processing device is configured to execute the computer readable program code to:
receive a pre-order for a product from a user;
collect location data of the user;
analyze the location data of the user to determine a proximity of the user from an organization location; and
receive a notification to procure the product for the user based in part on the proximity of the user from the organization location.

2. The system of claim 1, wherein the processing device configured to execute computer readable program code to collect location data of the customer comprises receiving the location data based on the location of the user's mobile device.

3. The system of claim 1, wherein the processing device configured to execute computer readable program code to collect location data of the user comprises identifying when the user enters an electronic fenced location.

4. The system of claim 1, wherein the processing device configured to execute computer readable program code to collect location data of the user comprises identifying a user location when the user enters the pre-order or at a time proximate to entering the pre-order; and identifying the user location at one or more later points in time.

5. The system of claim 1, wherein the processing device configured to execute computer readable program code to collect location data of the user comprises identifying a user location when the user is located a pre-determined distance away from the organization location.

6. The system of claim 1, wherein the processing device configured to execute computer readable program code to analyze the location data of the user comprises determining an estimate of a user arrival time at the organization location.

7. The system of claim 1, wherein the processing device configured to execute computer readable program code to analyze the location data of the user comprises:
determining an estimate of a user arrival time at the organization location;
determining an estimate of a procuring time related to a time it takes to procure the product from the pre-order; and
wherein receiving the notification to procure the product for the user based in part on the proximity of the user from the organization location comprises receiving the notification based on a comparison of the estimate of the user arrival time and the estimate of the procuring time.

8. The system of claim 1, wherein the processing device is further configured to execute computer readable program code to:
complete the pre-order for the product after the user is within a pre-determined proximity from the organization location by accessing a payment from a user account.

9. A computer program product, the computer program product comprising at least one non-transitory computer-readable medium having computer-readable program code portions embodied therein, the computer-readable program code portions comprising:
an executable portion configured for receiving a pre-order for a product from a user;
an executable portion configured for collecting location data of the user;
an executable portion configured for analyzing the location data of the user to determine a proximity of the user from an organization location; and
an executable portion configured for receiving a notification to procure the product for the user based in part on the proximity of the user from the organization location.

10. The computer program product of claim 9, wherein the executable portion configured for collecting location data of the customer comprises receiving the location data based on the location of the user's mobile device.

11. The computer program product of claim 9, wherein the executable portion configured for collecting location data of the user comprises identifying when the user enters an electronic fenced location.

12. The computer program product of claim 9, wherein the executable portion configured for collecting location data of the user comprises identifying a user location when the user enters the pre-order or at a time proximate to entering the pre-order; and identifying the user location at one or more later points in time.

13. The computer program product of claim 9, wherein the executable portion configured for collecting location data of the user comprises identifying a user location when the user is located a pre-determined distance away from the organization location.

14. The computer program product of claim 9, wherein the executable portion configured for analyzing the location data of the user comprises determining an estimate of a user arrival time at the organization location.

15. The computer program product of claim 9, wherein the executable portion configured for analyzing the location data of the user comprises
determining an estimate of a user arrival time at the organization location;
determining an estimate of a procuring time related to a time it takes to procure the product from the pre-order; and
wherein the executable portion configured for receiving the notification to procure the product for the user based in part on the proximity of the user from the organization location comprises receiving the notification based on a comparison of the estimate of the user arrival time and the estimate of the procuring time.

16. The computer program product of claim 9, wherein the computer-readable program code portions further comprise:
an executable portion configured for completing the pre-order for the product after the user is within a pre-determined proximity from the organization location by accessing a payment from a user account.

17. A method, comprising:
receiving, by a processing device, a pre-order for a product from a user;
collecting, by the processing device, location data of the user;
analyzing, by the processing device, the location data of the user to determine a proximity of the user from an organization location; and
receiving, by the processing device, a notification to procure the product for the user based in part on the proximity of the user from the organization location.

18. The method of claim 17, wherein collecting location data of the customer comprises receiving the location data based on the location of a user mobile device.

19. The system of claim 17, wherein collecting location data of the user comprises identifying when the user enters an electronic fenced location.

20. The system of claim 17, wherein collecting location data of the user comprises identifying a user location when the user enters the pre-order or at a time proximate to entering the pre-order; and identifying the user location at one or more later points in time.
